(19) United States
(12) Patent Application Publication
(10) Pub. No.: US 2013/0323633 A1
(43) Pub. Date: Dec. 5, 2013

(54) BRILLIANT TONER, DEVELOPER, TONER CARTRIDGE, PROCESS CARTRIDGE, AND IMAGE FORMING APPARATUS

(71) Applicant: FUJI XEROX CO., LTD., Tokyo (JP)

(72) Inventors: Shotaro TAKAHASHI, Kanagawa (JP); Masaru TAKAHASHI, Kanagawa (JP); Sakiko HIRAI, Kanagawa (JP); Atsushi SUGITATE, Kanagawa (JP); Shuji SATO, Kanagawa (JP)

(73) Assignee: FUJI XEROX CO., LTD., Tokyo (JP)

(21) Appl. No.: 13/673,401

(22) Filed: Nov. 9, 2012

(30) Foreign Application Priority Data
May 30, 2012 (JP) 2012-123390

(51) Int. Cl. G03G 9/00; G03G 21/18; G03G 15/08

(52) U.S. Cl. CPC G03G 9/0902; G03G 21/16; G03G 15/08; G03G 9/0819; G03G 9/08755; G03G 9/1132
USPC 430/105; 399/111; 399/252; 430/110.1; 430/110.3; 430/108.1; 430/109.4; 430/108.6; 430/110.2

(57) ABSTRACT

A brilliant toner includes toner particles which at least contain a brilliant pigment, a binder resin, and a release agent; and an external additive, wherein a ratio (X/Y) of a specific surface area X (m²/g), calculated from a projected image of the toner particles, to a BET specific surface area Y (m²/g) of the toner particles is from 0.3 to 1.0.

### CROSS-REFERENCE TO RELATED APPLICATIONS

This application is based on and claims priority under 35 USC 119 from Japanese Patent Application No. 2012-123390 filed May 30, 2012.

### BACKGROUND

1. Technical Field

The present invention relates to a brilliant toner, a developer, a toner cartridge, a process cartridge, and an image forming apparatus.

2. Related Art

In order to form an image having brilliance such as metal luster, a brilliant toner is used.

### SUMMARY

According to an aspect of the invention, there is provided a brilliant toner including toner particles which at least contain a brilliant pigment, a binder resin, and a release agent; and an external additive, wherein a ratio (X/Y) of a specific surface area X (m²/g), calculated from a projected image of the toner particles, to a BET specific surface area Y (m²/g) of the toner particles is from 0.3 to 1.0.

### BRIEF DESCRIPTION OF THE DRAWINGS

Exemplary embodiments of the present invention will be described in detail based on the following figures, wherein:

FIG. 1 is a cross-sectional view schematically illustrating a toner particle according to an exemplary embodiment;

FIG. 2 is a diagram schematically illustrating a configuration of an image forming apparatus according to an exemplary embodiment of the invention; and

FIG. 3 is a diagram schematically illustrating a configuration of a process cartridge according to an exemplary embodiment of the invention.

### DETAILED DESCRIPTION

Hereinafter, a brilliant toner, a developer, a toner cartridge, a process cartridge, and an image forming apparatus according to exemplary embodiments of the invention will be described.

### Brilliant Toner

A brilliant toner according to an exemplary embodiment of the invention (hereinafter, sometimes referred to as the toner according to the exemplary embodiment) includes toner particles which at least contain a brilliant pigment, a binder resin, and a release agent; and an external additive. In this case, a ratio (X/Y) of a specific surface area X (m²/g), calculated from a projected image of the toner particles, to a BET specific surface area Y (m²/g) of the toner particles is from 0.3 to 1.0.

Currently, a metallic toner using a brilliant pigment (brilliant toner) is being discussed. In order to obtain a metallic feeling, it is important that particles of the brilliant pigment have a large diameter and a flat shape. Particles of a toner, in which a binder resin is attached to the pigment particles having a large diameter and a flat shape, have a flat shape. Therefore, there may be more convex and concave portions than those of circular toner particles of the related art. Therefore, in some cases, inorganic particles, which are added as an external additive, are transferred to concave portions of surfaces of the toner particles and thus the inorganic particles do not work efficiently as the external additive. As a result, thermal powder characteristics and fluidity of the flat toner particles may further deteriorate. In particular, a problem of fogging may occur, far example, because the charge amount of toner is not maintained in a high-temperature and high-humidity environment.

The high-temperature and high-humidity environment described in the exemplary embodiment represents an environment of a temperature of 40° C. or higher and a humidity of 70% RH or higher.

By using the toner according to the exemplary embodiment, the occurrence of fogging is suppressed. The reason is not clear but is considered to be as follows.

The toner according to the exemplary embodiment contains toner particles which contain a brilliant pigment as a colorant. Particles of the brilliant pigment have a flaky shape and the toner particles containing the flaky brilliant pigment particles are likely to have a flat-shape. The flat toner particles may have more convex and concave portions on surfaces thereof than those of circular particles.

In the exemplary embodiment, a degree of convexity and concavity on the surfaces of the toner particles is defined by a ratio (X/Y) of a specific surface area X (m²/g), calculated from a projected image of the toner particles, to a BET specific surface area Y (m²/g) of the toner particles. It is considered that the specific surface area X calculated from the projected image of the toner particles represents the total charge amount of toner; the BET specific surface area Y of the toner particles represents a possibility of movement control of an external additive rather than the total charge amount; and the ratio (X/Y) represents the charge amount with respect to the easiness of the external additive being attached. Therefore, as convex and concave portions on the surfaces of the toner particles increase, a larger amount of external additive moves to the concave portions. As a result, thermal powder characteristics and fluidity deteriorate and fogging is likely to occur. When this phenomenon is represented by (X/Y), a value thereof decreases. On the other hand, when there is a too small amount of convex and concave portions on surfaces of toner particles, the attachment of an appropriate amount of external additive is suppressed and the external additive is easily desorbed. As a result, thermal powder characteristics and fluidity deteriorate and fogging is likely to occur. The present inventors have found that, when the ratio (X/Y), which represents a degree of the difference between the specific surface area X and the BET specific surface area Y, is from 0.3 to 1.0, the occurrence of fogging particularly in a high-temperature and high-humidity environment is suppressed. It is considered that, when the ratio (X/Y) is from 0.3 to 1.0, there is a small amount of fine convex and concave portions on the surfaces, which is detected with the BET method, and thus concentration of an external additive being attached to concave portions on the surfaces of the toner particles is suppressed. As a result, it is considered that the occurrence of fogging particularly in a high-temperature and high-humidity environment is suppressed.

In the exemplary embodiment, the ratio (X/Y) is from 0.3 to 1.0, and is preferably from 0.4 to 0.8 and more preferably from 0.45 to 0.7.

In the exemplary embodiment, the specific surface area X calculated from the projected image of the toner particles represents a value measured by the following method.

First, 0.1 part by weight of toner particles, 4 parts by weight of ion exchange water, and 0.01 part by weight of anionic surfactant (manufactured by DAI-ICHI KOGYO SEIYAKU CO., LTD., NEOGEN R) are mixed to prepare a dispersion. Next, the circularity of the dispersion is measured using a flow particle imaging instrument FPIA-3000 (manufactured by Sysmex Corporation). From the measurement result, the surface area (m²/number) per particle and the number of particles per volume (number/l) are obtained. In addition, the weight of particles per volume (g/l) is calculated from diluted concentration. By multiplying these values with each other, the specific surface area is calculated from the projected image.

Specific Surface Area X (m²/g)=Surface Area per Particle (m²/Number)÷weight of Particles per Volume (g/l)×Number of Particles Per Volume (Number/l)×2

Since a single surface is projected in FPIA-3000, multiplication by 2 is performed at the end.

In addition, in the exemplary embodiment, the BET specific surface area Y of the toner particles is a value measured with a nitrogen-substitution method using a BET surface area analyzer (SA3100, manufactured by Beckman Coulter Inc) as a measurement device. Specifically, 0.1 g of measurement sample is weighed and put into a sample tube, followed by degassing treatment and automatic measurement at multiple points. As a result, a numerical value is obtained as the BET specific surface area (m²/g).

In the toner according to the exemplary embodiment, when a solid image formed by the toner is irradiated with incident light at an incident angle of −45° using a goniophotometer, it is preferable that a ratio (A/B) of a reflectance A at a light-receiving angle of +30° to a reflectance B at a light-receiving angle of −30° be from 2 to 100.

In the exemplary embodiment, “brilliance” represents that, when an image formed by the toner according to the exemplary embodiment is viewed, the image has a brilliance similar to metallic luster.

A ratio (A/B) of 2 or greater indicates that the amount of reflection on a side on which light is incident (− angle side) is larger than the amount of reflection on the opposite side (+ angle side) to the light-incident side, that is, it indicates that scattered reflection of the incident light is suppressed. When scattered reflection in which incident light is reflected in various directions occurs and the reflected light is visually inspected, the color thereof appears to be matte. Therefore, when the ratio (A/B) is less than 2 and the reflected light is visually inspected, there are cases where the gloss thereof is not recognized and brilliance deteriorates.

On the other hand, when the ratio (A/B) is greater than 100, a view angle where reflected light is visible is too narrow. As a result, since there are many mirror-reflection light components, the color appears to be black depending on viewing angles. In addition, when a toner has the ratio (A/B) of greater than 100, the manufacture of such toner is difficult.

The ratio (A/B) is more preferably from 50 to 100, still more preferably from 60 to 90, and even still more preferably from 70 to 80.

### Measurement of Ratio (A/B) Using Goniophotometer

First, the incident angle and the light-receiving angle will be described. In measurement using a goniophotometer of the exemplary embodiment, an incident angle is set to −45° because measurement sensitivity for an image having a wide range of glossiness is high.

In addition, the light-receiving angles are set to −30° and +30° because a measurement sensitivity is the highest when brilliant images and non-brilliant images are evaluated.

Next, a method of measuring the ratio (A/B) will be described.

In the exemplary embodiment, when the ratio (A/B) is measured, first, “a solid image” is formed with the following method. A developer unit of DocuCentre-III C7600 (manufactured by Fuji Xerox Co., Ltd.) is filled with a sample developer and a solid image is formed on a recording paper (OK TOPCOAT+, manufactured by Oji Paper Co., Ltd.) under conditions of a fixing temperature of 190° C., a fixing pressure of 4.0 kg/cm², and an amount of toner particles deposited of 4.5 g/cm². “The solid image” described herein represents an image having a coverage rate of 100%.

An image portion of the formed solid image is irradiated with incident light at an incident angle of −45° using a spectro-goniophotometer GC 5000L (manufactured by NIPPON DENSHOKU INDUSTRIES CO., LTD.) as a goniophotoineter, and a reflectance A at a light-receiving angle of +30° and a reflectance B at a light-receiving angle of −30° are measured. The reflectances A and B are respectively obtained by performing measurement with light in a wavelength range of 400 nm to 700 nm at intervals of 20 nm and calculating the average of reflectances of the respective wavelengths. The ratio (A/B) is calculated from the measurement results.

### Configuration of Toner

It is preferable that the toner according to the exemplary embodiment satisfy the following requirements (1) and (2) from the viewpoint of satisfying the above-described ratio (A/B):

(1) An average equivalent-circle diameter D is greater than an average maximum thickness C of the toner particles; and

(2) When a cross section of a toner particle in a thickness direction thereof is observed, the number of pigment particles arranged so that an angle formed by a long axis direction of the toner particle in the cross section and a long axis direction of a pigment particle is in the range of −30° to +30° is greater than or equal to 60% with respect to the total number of pigment particles observed.

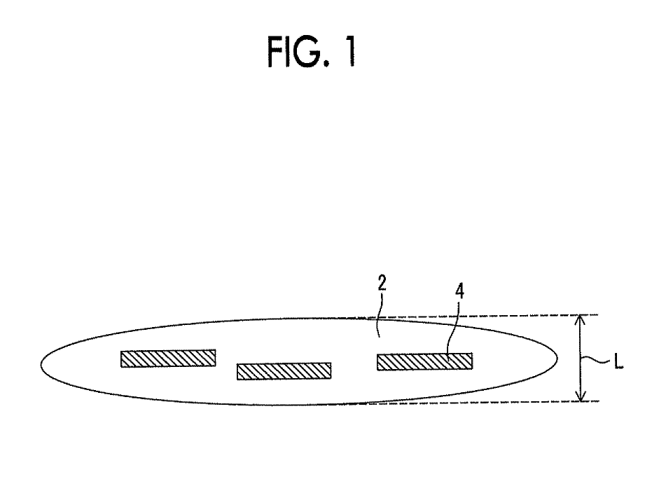

FIG. 1 is a cross-sectional view schematically illustrating a toner particle which satisfies the above-described requirements (1) and (2). The schematic diagram illustrated in FIG. 1 is a cross-sectional view taken in the thickness direction of the toner particle.

A toner particle 2 illustrated in FIG. 1 has a flat shape in which an equivalent-circle diameter is greater than a thickness L and contains flaky pigment particles 4 (corresponding to the brilliant pigment).

As illustrated in FIG. 1, when the toner particle 2 has a flat shape in which the equivalent-circle diameter is greater than a thickness L, in development and transfer processes for image formation, toner particles have a tendency to move to an image holding member, an intermediate transfer medium, a recording medium, and the like so as to cancel out charges of the toner particles to the maximum. Therefore, it is considered that the toner particles are arranged such that an attachment area thereof is a maximum. That is, it is considered that the flat toner particles are arranged such that on a recording medium onto which the toner is finally transferred, a flat surface thereof faces a surface of the recording medium. In addition, it is considered that, in a fixing process for image formation, the flat toner particles are also arranged due to a pressure during fixing such that the flat surface thereof faces the surface of the recording medium.

Therefore, it is considered that the pigment particles, which satisfy the requirement “an angle formed by a long axis direction of the toner particle in the cross section and a long axis direction of a pigment particle is in the range of −30° to +30° ” among the flaky pigment particles included in the toner, are arranged such that a surface having the maximum area faces the surface of the recording medium. It is considered that, when an image formed with the above-described method is illuminated with light, a ratio of pigment particles which scatter and reflect incident light is suppressed; and as a result, the above-described range of ratio (A/B) is achieved. In addition, it is considered that, when the ratio of pigment particles which scatter and reflect incident light is suppressed, the intensity of reflected light greatly varies depending on viewing angles; and as a result, more ideal brilliance is obtained.

Next, components of the toner according to the exemplary embodiment will be described.

### Brilliant Pigment

As the brilliant pigment used in the exemplary embodiment, for example, the following examples may be used. The brilliant pigment is not limited as long as it has brilliance, and examples thereof include powders of metals such as aluminum, brass, bronze, nickel, stainless steel, and zinc; flaky inorganic crystal substrates coated with a thin layer such as mica, barium sulfate, lamellar silicate, and lamellar aluminum silicate which are coated with titanium oxide or yellow iron oxide; single-crystal plate-like titanium oxides; basic carbonates; bismuth oxychlorides; natural guanines; flaky glass powders; and metal-deposited flaky glass powders.

Among of these, the brilliant pigment containing aluminum is preferably used.

The content of the brilliant pigment in the toner according to the exemplary embodiment is preferably from 1 part by weight to 70 parts by weight and more preferably from 5 parts by weight to 50 parts by weight, with respect to 100 parts by weight of a binder resin described below.

### Binder Resin

Examples of the binder resin used in the exemplary embodiment include polyester resins; ethylene resins such as polyethylene and polypropylene; styrene resins such as polystyrene and α-polymethylstyrene; (meth)acrylic resins such as polymethyl methacrylate and polyacrylonitrile; polyamide resin; polycarbonate resins; polyether resins; and copolymer resins thereof. Among these resins, polyester resins are preferably used from the viewpoints of high smoothness on a surface of a fixed image and superior brilliance.

Hereinafter, polyester resins which are particularly preferably used will be described.

A polyester resin according to the exemplary embodiment is usually obtained by, for example, polycondensation of polycarboxylic acid and polyol.

Examples of the polycarboxylic acid include aromatic carboxylic acids such as terephthalic acid, isophthalic acid, phthalic anhydride, trimellitic anhydride, pyromellitic acid, and naphthalenedicarboxylic acid; aliphatic carboxylic acids such as maleic anhydride, fumaric acid, succinic acid, alkenyl succinic anhydride, and adipic acid; and alicyclic carboxylic acids such as cyclohexanedicarboxylic acid. As the polycarboxylic acid, the above examples are used alone or in a combination of two or more kinds.

Among these, aromatic carboxylic acids are preferably used. In addition, in order to provide a cross-linked structure or a branched structure for securing a superior fixing property, dicarboxylic acids are preferably used in combination with trivalent or higher valent carboxylic acids (such as trimellitic acids or anhydrides thereof).

Examples of the polyol include aliphatic diols such as ethylene glycol, diethylene glycol, triethylene glycol, propylene glycol, butanediol, hexanediol, neopentyl glycol, and glycerol; alicyclic diols such as cyclohexanediol, cyclohexanedimethanol, and hydrogenated bisphenol A; and aromatic diols such as ethylene oxide adducts of bisphenol A and propylene oxide adducts of bisphenol A. As the polyol, the above examples are used alone or in a combination of two or more kinds.

Among the examples of the polyol, aromatic dials and alicyclic diols are preferable and aromatic diols are more preferable. In addition, in order to provide a cross-linked structure or a branched structure for securing a superior fixing property, diols are preferably used in combination with trivalent or higher valent polyols (such as glycerol, trimethylolpropane, and pentaerythritol).

### Method of Preparing Polyester Resin

A method of preparing a polyester resin is not particularly limited and a general polyester polymerization method of causing an acid component and an alcohol component to react with each other is used. For example, a direct polycondensation method or a transesterification method is used depending on the kind of monomers. When the acid component and the alcohol component are caused to react with each other, the molar ratio (acid component/alcohol component) varies depending on reaction conditions or the like, but usually, is preferably about 1/1 in order to increase the molecular weight.

Examples of a catalyst used for the manufacture of the polyester resin include alkali metal compounds such as sodium and lithium; alkaline earth metal compounds such as magnesium and calcium; metal compounds such as zinc, manganese, antimony, titanium, tin, zirconium, and germanium; phosphite compounds; phosphate compounds; and amine compounds.

### Release Agent

Examples of a release agent used in the exemplary embodiment include paraffin waxes such as low-molecular weight polypropylene and low-molecular weight polyethylene; silicone resins, rosins, rice waxes, and carnauba waxes. The melting point of the release agent is preferably from 50° C. to 100° C. and more preferably from 60° to 95°.

The content of the release agent in the toner is preferably from 0.5% by weight to 15% by weight and more preferably from 1.0% by weight to 12% by weight.

### Other Additives

In the exemplary embodiment, in addition to the above-described components, various components such as an internal additive, a charge-controlling agent, inorganic powder (inorganic particles), and organic particles may be optionally used.

Examples of the charge-controlling agent include quaternary ammonium salt compounds; nigrosine compounds, dyes containing a complex of aluminum, iron, chromium, or the like; and triphenylmethane pigments.

Examples of the inorganic particles include well-known inorganic particles such as silica particles, titanium oxide particles, alumina particles, cerium oxide particles, and particles obtained by hydrophobizing the surfaces of these particles. As the inorganic particles, the above examples are used alone or in a combination of two or more kinds. Among these, silica particles, which have a lower refractive index than that of the binder resin, are preferably used. In addition, surfaces of silica particles may treated with various surface treating agents, and, for example, a silane coupling agent, a titanium coupling agent, and silicone oil are preferably used for the surface treatment.

### Characteristics of Toner

### Average Maximum Thickness C and Average Equivalent-Circle Diameter D

As described above in (1), in the toner according to the exemplary embodiment, it is preferable that an average equivalent-circle diameter D be greater than an average maximum thickness C. In addition, the ratio (C/D) of the average maximum thickness C to the average equivalent-circle diameter D is preferably in the range of from 0.001 to 0.500, more preferably in the range of from 0.010 to 0.200, and still more preferably in the range of from 0.050 to 0.100.

By setting the ratio (C/D) to be greater than or equal to 0.001, toner strength is secured and fracture due to stress generated during image formation is suppressed. Therefore, a decrease in the amount of toner particles charged, caused by the pigment being exposed, and fogging, occurring as a result of the decrease, are suppressed. In addition, by setting the ratio (C/D) to be less than or equal to 0.500, superior brilliance may be obtained.

The average maximum thickness C and the average equivalent-circle diameter D are measured with the following method.

Toner particles are placed on a smooth surface and uniformly dispersed through vibration. 1000 toner particles are observed using a color laser microscope “VK-9700” (manufactured by Keyence Corporation) at a magnification of 1000 times to measure the maximum thicknesses C and the equivalent-circle diameters D of surfaces seen from the above, and the arithmetic mean values thereof are obtained. Angle Formed by Long Axis Direction of Toner Particle in Cross Section and Long Axis Direction of Pigment Particle

As described above in (2), when a cross section of a toner particle in a thickness direction thereof is observed, it is preferable that the number of pigment particles arranged so that an angle formed by a long axis direction of the toner particle in the cross section and a long axis direction of a pigment particle is in the range of −30° to +30° be greater than or equal to 60% with respect to the total number of pigment particles observed. Furthermore, the number is preferably from 70% to 95% and more preferably from 80% to 90%.

By setting the number to be greater than or equal to 60%, superior brilliance may be obtained.

A method of observing a cross section of a toner will be described.

Toner particles are embedded with a bisphenol A type liquid epoxy resin and a curing agent to prepare a cutting sample. Next, the cutting sample is cut by a diamond knife of a cutting machine (in the exemplary embodiment, a LEICA ultramicrotome (manufactured by Hitachi High-Technologies Corporation) is used) at −100° C. or lower to prepare an observing sample. Cross sections of toner particles of the observing sample are observed with a transmission electron microscope (TEM) at a magnification of 5000 times. With regard to 1000 observed toner particles, the number of pigment particles arranged so that an angle formed by a long axis direction of a toner particle in the cross section and a long axis direction of a pigment particle is in the range of −30° to +30° is obtained using image analysis software and a ratio thereof is calculated.

“The long axis direction of a toner particle in the cross section” represents a direction perpendicular to the thickness direction of a toner particle in which the average equivalent-circle diameter D is greater than an average maximum thickness C, and “the long axis direction of a pigment particle” represents a length direction of the pigment particle.

In addition, the volume average particle diameter of the toner according to the exemplary embodiment is preferably from 1 μm to 30 μm, more preferably from 3 μm to 20 μm, and still more preferably from 5 μm to 10 μm.

The volume average particle diameter D₅₀ᵥ is obtained as follows. The cumulative distributions of particle sizes from a smaller particle size side in terms of volume and number are drawn in a particle size range (channel) which is divided based on the particle size distribution measured using a measurement instrument such as Multisizer II (manufactured by Beckman Coulter, Inc.). A particle diameter which is an accumulated value of 16% is defined as Volume D₁₆ᵥ and Number D₁₆ₚ, a particle diameter which is an accumulated value of 50% is defined as Volume D₅₀ᵥ and Number D₅₀ₚ, and a particle diameter which is an accumulated value of 84% is defined as Volume D₈₄ᵥ and Number D₈₄ₚ. Using these, the volume average particle size distribution index (GSD_{V}) is calculated according to an expression of (D₈₄ᵥ/D₁₆ᵥ)^{1/2}.

### Method of Preparing Toner

The toner according to the exemplary embodiment may be prepared by preparing toner particles and adding an external additive to the toner particles.

A method of preparing toner particles is not particularly limited, and examples thereof include well-known methods including a dry method such as a kneading and pulverizing method and a wet method such as an emulsion aggregation method and a suspension polymerization method.

In the kneading and pulverizing method, the respective materials including a colorant are mixed; the resultant is melted and kneaded with a kneader, an extruder, and the like; and the obtained melted and kneaded material is coarsely pulverized and finely pulverized with a jet mill or the like, followed by classification with a wind classifier. As a result, toner particles having a desired particle diameter is obtained.

Among the methods, an emulsion aggregation method is preferable from the viewpoints that the shape and particle diameter of toner particles are easily controlled and a control range of a structure of toner particles, such as a core-shell structure, is wide. In particular, in order to set the ratio (X/Y) to be in the above-described range of the exemplary embodiment, in processes of preparing a toner described below, for example, a method of preparing toner particles and heating the toner particles with the warm air; reducing the sizes of resin particles which are additionally added; or performing stirring faster during aggregation and raising the temperature, may be used. Hereinafter, a method of preparing toner particles with the emulsion aggregation method will be described in detail.

The emulsion aggregation method according to the exemplary embodiment includes an emulsion process of emulsifying base materials of toner particles and forming resin particles (emulsified particles); an aggregation process of forming aggregates of the resin particles; and a coalescence process of coalescing the aggregates.

### Emulsion Process

A resin particle dispersion may be prepared by a disperser applying a shearing force to a solution, in which an aqueous medium and a binder resin are mixed, to be emulsified, as well as by using well-known polymerization methods such as an emulsion polymerization method, a suspension polymerization method, and a dispersion polymerization method. At this time, particles may be formed by heating a resin component to lower the viscosity thereof. In addition, in order to stabilize the dispersed resin particles, a dispersant may be used. Furthermore, when resin is dissolved in an oil-based solvent having relatively low solubility in water, the resin is dissolved in the solvent and particles thereof are dispersed in water with a dispersant and a polymer electrolyte, followed by heating and reduction in pressure to evaporate the solvent. As a result, the resin particle dispersion is prepared.

Examples of the aqueous medium include water such as distilled water or ion exchange water; and alcohols, and water is preferable.

In addition, examples of the dispersant which is used in the emulsion process include a water-soluble polymer such as polyvinyl alcohol, methyl cellulose, ethyl cellulose, hydroxyethyl cellulose, carboxymethyl cellulose, sodium polyacrylate, or poly(sodium methacrylate); a surfactant such as an anionic surfactant (for example, sodium dodecylbenzenesulfonate, sodium octadecylsulfate, sodium oleate, sodium laurate, or potassium stearate), a cationic surfactant (for example, laurylamine acetate, stearylamine acetate, or lauryltrimethylammonium chloride), a zwitterionic surfactant (for example, lauryl dimethylamine oxide), or a nonionic surfactant (for example, polyoxyethylene alkyl ether, polyoxyethylene alkyl phenyl ether, or polyoxyethylene alkylamine); and an inorganic salt such as tricalciumphosphate, aluminum hydroxide, calcium sulfate, calcium carbonate, or barium carbonate.

Examples of the disperser which is used for preparing an emulsion include a homogenizer, a homomixer, a pressure kneader, an extruder, and a media disperser. With regard to the size of the resin particles, the average particle diameter (volume average particle diameter) thereof is preferably less than or equal to 1.0 μm, more preferably from 60 nm to 300 nm, and still more preferably from 150 nm to 250 nm. When the volume average particle diameter is greater than or equal to 60 nm, the resin particles are likely to be unstable in the dispersion and thus the aggregation of the resin particles may be easy. In addition, when the volume average particle diameter is less than or equal to 1.0 μm, the particle size distribution of the toner particles may be narrowed.

When a release agent particle dispersion is prepared, a release agent is dispersed in water with an ionic surfactant and a polyelectrolyte such as a polyacid or a polymeric base and the resultant is heated at a temperature higher than or equal to the melting point of the release agent, followed by dispersion using a homogenizer to which strong shearing force is applied and a pressure extrusion type disperser. Through the above-described process, a release agent particle dispersion is obtained. During the dispersion, an inorganic compound such as polyaluminum chloride may be added to the dispersion. Preferable examples of the inorganic compound include polyaluminum chloride, aluminum sulfate, basic aluminum chloride (BAC), polyaluminum hydroxide, and aluminum chloride. Among these, polyaluminum chloride and aluminum sulfate are preferable. The release agent particle dispersion is used in the emulsion aggregation method, but may also be used when the toner is prepared in the suspension polymerization method.

Through the dispersion, the release agent particle dispersion having release agent particles with a volume average particle diameter of 1 μm or less is obtained. It is more preferable that the volume average particle diameter of the release agent particles be from 100 nm to 500 nm.

When the volume average particle diameter is greater than or equal to 100 nm, in general, although also being affected by properties of a binder resin to be used, it is easy to mix a release agent component into toner. In addition, when the volume average particle diameter is less than or equal to 500 nm, the dispersal state of the release agent in the toner may be satisfactory.

When a particle dispersion of the colorant (brilliant pigment) is prepared, a well-known dispersion method may be used. For example, general dispersion units such as a rotary-shearing homogenizer, a ball mill having a medium, a sand mill, a dyno mill, or an ultimizer are used, but the dispersion method is not limited thereto. The colorant is dispersed in water with an ionic surfactant and a polyelectrolyte such as a polyacid or a polymeric base. The volume average particle diameter of the dispersed colorant particles may be less than or equal to 20 μm, but preferably from 3 μm to 16 μm because the colorant is uniformly dispersed in the toner without impairing aggregability.

In addition, the brilliant pigment and a binder resin may be dispersed and dissolved in a solvent and mixed and the resultant may be dispersed in water through phase-transfer emulsification or shearing emulsification, to prepare a dispersion of the brilliant pigment coated with the binder resin.

### Aggregation Process

In the aggregation process, the resin particle dispersion, the colorant particle dispersion, the release agent particle dispersion and the like are mixed to obtain a mixture and the mixture is heated at the glass transition temperature or lower of the resin particles and aggregated to form aggregated particles. In most cases, the aggregated particles are formed by adjusting the pH value of the mixture to be acidic under stirring. Under the above-described stirring conditions, the ratio (X/Y) and the ratio (C/D) may be in a preferable range. Specifically, by performing the stirring faster and applying heat in the stage of forming aggregated particles, the ratio (X/Y) may increase and the ratio (C/D) may decrease. In addition, by performing the stirring slower and applying heat at a low temperature, the ratio (C/D) may increase. The pH value is preferably from 2 to 7. At this time, use of a coagulant is also effective.

In the aggregation process, the release agent particle dispersion and other various dispersions such as the resin particle dispersion may be added and mixed at once or in two or more batches.

As the coagulant, a surfactant having a reverse polarity to that of a surfactant which is used as the dispersant; an inorganic metal salt; and a divalent or higher valent metal complex may be preferably used. In particular, the metal complex is particularly preferable because the amount of the surfactant used may be reduced and a charge performance is improved.

Preferable examples of the inorganic metal salt include an aluminum salt and a polymer thereof. In order to obtain a narrower particle size distribution, a divalent inorganic metal salt is preferable to a monovalent inorganic metal salt, a trivalent inorganic metal salt is preferable to a divalent inorganic metal salt, and a tetravalent inorganic metal salt is preferable to a trivalent inorganic metal salt. In addition, when inorganic metal salts having the same valence are compared, a polymer type of inorganic metal salt polymer is more preferable.

In the exemplary embodiment, in order to obtain a narrower particle size distribution, a tetravalent inorganic metal salt containing aluminum is preferably used.

In addition, after the aggregated particles have desired particle sizes, the resin particle dispersion is additionally added (coating process). As a result, a toner having a configuration in which the surfaces of core aggregated particles are coated with resin may be prepared. In this case, the release agent and the colorant are not easily exposed to the surface of the toner, which is preferable from the viewpoints of a charging property and developability. When additional components are added, a coagulant may be added or the pH value may be adjusted before the addition.

The volume average particle diameter of the resin particle dispersion, which is additionally added in the coating process, is preferably less than the volume average particle diameter of the resin particle dispersion, which is used in the aggregation process; and specifically, is preferably from 30 nm to 120 nm and more preferably from 50 nm to 80 nm. As a result, the ratio (X/Y) may further increase.

As described above, by setting the volume average particle diameter of the resin particle dispersion, which is additionally added in the coating process, to be less than the volume average particle diameter of the resin particle dispersion, which is used in the aggregation process, the ratio (X/Y) is adjusted. The reason is not clear but is considered to be as follows. By setting the volume average particle diameter of the resin particle dispersion, which is additionally added in the coating process, to be less than the volume average particle diameter of the resin particle dispersion, which is used in the aggregation process, the resin particles having a small size, which are additionally added, are attached to concave portions on surfaces of the aggregated particles. As a result, convex and concave portions on the surfaces of the aggregated particle are reduced. It is considered that, when the convex and concave portions on the surfaces of the aggregated particle are reduced, convex and concave portions on surfaces of toner particles, which are obtained by coalescing the aggregated particles, are also reduced. It is considered that, by reducing the convex and concave portions on the surfaces of the toner particles, the ratio (X/Y) is adjusted to be in a range of from 0.3 to 1.0.

### Coalescing Process

In the coalescing process, under stirring conditions based on the aggregation process, by increasing the pH value of a suspension of the aggregated particles to be in a range of 3 to 9, aggregation is stopped. Then, heating is performed at the glass transition temperature or higher of the resin to coalesce the aggregated particles. In addition, when the resin is used for coating, the resin is also coalesced and coats the core aggregated particles. The heating time may be determined according to a coalescing degree and may be approximately from 0.5 hour to 10 hours.

After coalescing, cooling is performed to obtain coalesced particles. In addition, in a cooling process, a cooling rate may be reduced around the glass transition temperature of the resin (the range of the glass transition temperature±10° C.), that is, so-called slow cooling may be performed to promote crystallization.

The coalesced particles which are obtained after coalescing may be subjected to a solid-liquid separation process such as filtration, and optionally to a cleaning process and a drying process to obtain toner particles.

In the exemplary embodiment, after the drying process, a heating process of heating the toner particles may be provided. By providing the heating process, the convex and concave portions on the surfaces of the toner particles are reduced and thus the ratio (A/B) may be adjusted to be in the range of from 0.3 to 1.0.

Due to the relationship with the glass transition temperature of the binder resin, the heating temperature of the toner particles in the heating process is preferably from (Tg −30° C.) to (Tg −10° C.) and more preferably from (Tg −20° C.) to (Tg −15° C.). In addition, in the heating process, heating may be performed while stirring the toner particles or blowing the warm air to the toner particles to scatter the toner particles.

In order to adjust charging, impart fluidity, and impart a charge exchange property, inorganic oxide or the like which is represented by silica, titania, and alumina may be added and attached to the obtained toner particles as an external additive. The above processes may be performed with a V-shape blender, a Henschel mixer, or a Loedige mixer and the attachment may be performed in plural steps. The amount of the external additive added is preferably from 0.1 part by weight to 5 parts by weight and more preferably from 0.3 part by weight to 2 parts by weight, with respect to 100 parts by weight of the toner particles.

Furthermore, optionally, after external addition, coarse particles of toner may be removed using an ultrasonic sieving machine, a vibrating sieving machine, or a wind classifier.

In addition to the inorganic oxide or the like, other components (particles) such as a charge-controlling agent, organic particles, a lubricant, and an abrasive may be added as an external additive.

The charge-controlling agent is not particularly limited, and a colorless or light-color material is preferably used. Examples thereof include quaternary ammonium salt compounds; nigrosine compounds, dyes containing a complex of aluminum, iron, chromium, or the like; and triphenylmethane pigments.

Examples of the organic particles include particles of vinyl resins, polyester resins, silicone resins, and the like, which are usually used for surfaces of toner particles as the external additive. The organic particles and inorganic particles are used as a fluid aid, a cleaning aid, or the like.

Examples of the lubricant include fatty acid amides such as ethylene bis stearamide and oleamide; and fatty acid metal salts such as zinc stearate and calcium stearate.

Examples of the abrasive include silica, alumina, and cerium oxide described above.

### Developer

The toner according to the exemplary embodiment may be used as a single-component developer as it is or a two-component developer in which a carrier is mixed with the toner.

The carrier which may be used for the two-component developer is not particularly limited, and a well-known carrier may be used. For example, a resin-coated carrier which has a resin coating layer on the surface of a core material formed of magnetic metal such as iron oxide, nickel, or cobalt and magnetic oxide such as ferrite or magnetite; and a magnetic powder-dispersed carrier may be used. In addition, a resin-dispersed carrier in which a conductive material and the like are dispersed in a matrix resin may be used.

Examples of the coating resin and the matrix resin which are used for the carrier include polyethylene, polypropylene, polystyrene, polyvinyl acetate, polyvinyl alcohol, polyvinyl butyral, polyvinyl chloride, polyvinyl ether, polyvinylketone, vinyl chloride-vinyl acetate copolymer, styrene-acrylic acid copolymer, linear silicone resin having an organosiloxane bond or a modified product thereof, fluororesin, polyester, polycarbonate, phenol resin, and epoxy resin. However, the coating resin and the matrix resin are not limited to these examples.

Examples of the conductive material include metals such as gold, silver, and copper, carbon black, titanium oxide, zinc oxide, barium sulfate, aluminum borate, potassium titanate, and tin oxide. However, the conductive material is not limited to these examples.

In addition, examples of the core material of the carrier include a magnetic metal such as iron, nickel or cobalt, a magnetic oxide such as ferrite or magnetite, and glass beads. In order to apply a magnetic brush method to the carrier, a magnetic material is preferable. In general, the volume average particle diameter of the core material of the carrier is from 10 μm to 500 μm and preferably from 30 μm to 100 μm.

In order to coat the surface of the core material of the carrier with resin, there may be used, for example, a coating method using a coating layer-forming solution which is obtained by dissolving the coating resin and optionally various additives in an appropriate solvent. The solvent is not particularly limited and may be selected according to coating resin to be used, coating aptitude, and the like.

Specific examples of the resin coating method include a dipping method in which the core material of the carrier is dipped in the coating layer-forming solution, a spray method in which the coating layer-forming solution is sprayed on the surface of the core material of the carrier, a fluid bed method in which the coating layer-forming solution is sprayed on the core material of the carrier in a state of floating through flowing air, and a kneader coater method in which the core material of the carrier and the coating layer-forming solution are mixed in a kneader coater and the solvent is removed.

In the two-component developer, the mixing ratio (weight ratio) of the toner according to the exemplary embodiment and the carrier is preferably from 1:100 to 30:100 (toner:carrier) and more preferably 3:100 to 20:100.

### Image Forming Apparatus

An image forming apparatus according to the exemplary embodiment of the invention includes an image holding member; a charging device that charges a surface of the image holding member; a latent image forming device that forms an electrostatic latent image on the surface of the image holding member; a developing device that develops the electrostatic latent image with the developer containing the brilliant toner according to the exemplary embodiment to form a toner image; and a transfer device that transfers the toner image, formed on the surface of the image holding member, onto a recording medium.

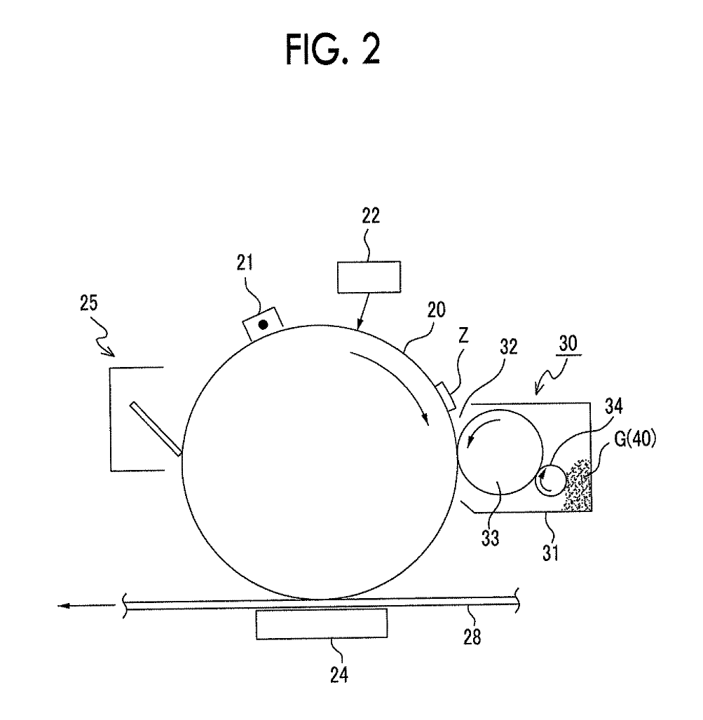

FIG. 2 is a diagram schematically illustrating a configuration of an image forming apparatus according to an exemplary embodiment of the invention including a developing device to which the toner according to the exemplary embodiment is applied.

In the same drawing, the image forming apparatus according to the exemplary embodiment include a photosensitive drum 20 as an image holding member which rotates in a predetermined direction. In the vicinity of this photosensitive drum 20, a charging device 21 which charges the photosensitive drum 20; an exposure device 22 as an example of a latent image forming apparatus which forms an electrostatic latent image Z on the photosensitive drum 20; a developing device 30 which visualizes the electrostatic latent image Z formed on the photosensitive drum 20; a transfer device 24 which transfers a toner image, visualized on the photosensitive drum 20, onto a recording paper 28 which is a transfer medium; and a cleaning device 25 which cleans toner remaining on the photosensitive drum 20 are disposed in order.

In the exemplary embodiment, as illustrated in FIG. 2, the developing device 30 includes a developer housing 31 which accommodates a developer G containing a toner 40. This developer housing 31 is provided with an opening for development 32 opposite the photosensitive drum 20, and a developing roller (development electrode) 33 as a toner holding member is disposed toward the opening for development 32. By applying a predetermined developing bias to the developing roller 33, a development field is formed at a region (development region) between the photosensitive drum 20 and the developing roller 33. Furthermore, in the developer housing 31, a charge injecting roller (injecting electrode) 34 as a charge injecting member is provided opposite the developing roller 33. In particular, in the exemplary embodiment, the charge injecting roller 34 also serves as a toner supply roller for supplying the toner 40 to the developing roller 33.

A rotating direction of the charge injecting roller 34 may be appropriately selected. However, from the viewpoints of a toner supply property and a charge injecting property, it is preferable that the charge injecting roller 34 have a configuration of rotating at the opposite position to the developing roller 33 in the same direction and at different circumferential speeds (for example, with a difference of 1.5 times or higher); and injecting charges to the toner 40 which is positioned at and slides against the region between the charge injecting roller 34 and the developing roller 33.

Next, the operation of the image forming apparatus according to the exemplary embodiment will be described.

Once an image forming process starts, a surface of the photosensitive drum 20 is charged by the charging device 21, the exposure device 22 forms the electrostatic latent image Z on the charged photosensitive drum 20, and the developing device 30 visualizes the electrostatic latent image Z to obtain a toner image. Then, the toner image on the photosensitive drum 20 is transported to a transfer position, and the transfer device 24 electrostatically transfers the toner image, formed on the photosensitive drum 20, onto the recording paper 28 as the transfer medium. Toner remaining on the photosensitive drum 20 is cleaned by the cleaning device 25. Next, the toner image is fixed on the recording paper 28 by a fixing device (not illustrated) and thus an image is obtained.

### Process Cartridge and Toner Cartridge

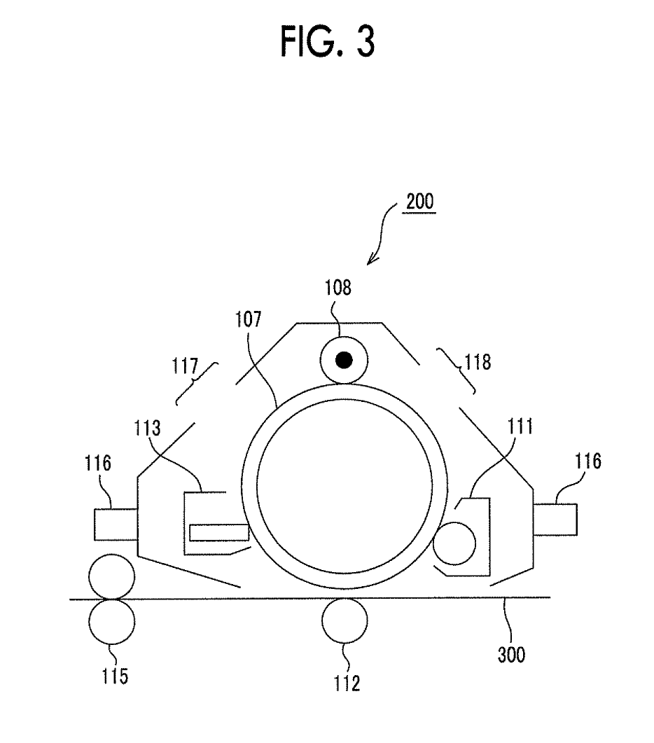

FIG. 3 is a diagram schematically illustrating a configuration example of a process cartridge according to an exemplary embodiment of the invention. The process cartridge according to the exemplary embodiment accommodates the above-described toner according to the exemplary embodiment and a toner holding member which holds and transports the toner.

A process cartridge 200 illustrated in FIG. 3 is configured by integrally combining a photoreceptor 107 as an image holding member, a charging roller 108, a developing device 111 which accommodates the above-described toner according to the exemplary embodiment, a photoreceptor cleaning device 113, an opening for exposure 118, and an opening for erasing and exposure 117 through a mounting rail 116. This process cartridge 200 is detachable from an image forming apparatus main body including a transfer device 112, a fixing device 115, and another component (not illustrated), and forms an image forming apparatus with the image forming apparatus main body. In FIG. 3, reference numeral 300 represents a transfer medium.

The process cartridge 200 illustrated in FIG. 3 includes the charging device 108, the developing device 111, the cleaning device 113, the opening for exposure 118, and the opening for erasing and exposure 117. However, these devices may be selectively combined. The process cartridge according to the exemplary embodiment includes the developing device 111 and at least one kind selected from a group consisting of the photoreceptor 107, the charging device 108, the cleaning device (cleaning unit) 113, the opening for exposure 118, and the opening for erasing and exposure 117.

Next, a toner cartridge according to an exemplary embodiment of the invention will be described. The toner cartridge according to the exemplary embodiment is detachable from an image forming apparatus and accommodates a toner which is supplied to a developing unit provided in the image forming apparatus, in which the toner is the above-described toner according to the exemplary embodiment. The toner cartridge according to the exemplary embodiment has only to accommodate at least a toner, and may accommodate, for example, a developer according to a configuration of an image forming apparatus.

The image forming apparatus illustrated in FIG. 2 has a configuration in which a toner cartridge (not illustrated) is detachable therefrom, and the developing device 30 is connected to the toner cartridge through a toner supply tube (not illustrated). In addition, when there is little toner accommodated in the toner cartridge, the toner cartridge may be replaced with another one.

### EXAMPLES

Hereinafter, the exemplary embodiments will be described in detail with reference to Examples and Comparative Examples, but the exemplary embodiments are not limited to the examples. “Part” and “%” represent “part by weight” and “% by weight” unless specified otherwise.

### Method of Measuring Volume Average Particle Diameter of Resin Particle Dispersion

The volume average particle diameter of a resin particle dispersion is measured with a laser diffraction particle size distribution analyzer (manufactured by Horiba Ltd., LA-700).

### Synthesis of Binder Resin (1)

Dimethyl adipate: 74 parts

Dimethyl terephthalate: 192 parts

Bisphenol A ethylene oxide adduct: 216 parts

Ethylene glycol: 38 parts

Tetrabutoxy titanate (catalyst): 0.037 part

The above components are put into a two-necked flask which is heated and dried, nitrogen gas is introduced into a container to maintain an inert atmosphere, and the temperature is raised under stirring, followed by copolycondensation at 160° C. for 7 hours. Then, the resultant is heated to 220° C. while gradually reducing the pressure to 10 Torr and held for 4 hours. The pressure is temporarily returned to normal pressure and 9 parts of trimellitic anhydride is added thereto. The pressure is reduced to 10 Torr again and the resultant is held at 220° C. for 1 hour. As a result, a binder resin (1) is synthesized.

The glass transition temperature (Tg) of the binder resin (1) is measured with a differential scanning calorimeter (manufactured by Shimadzu Corporation, DSC-50) according to ASTMD 3418-8 under conditions of a temperature range of room temperature (25° C.) to 150° C. and a rate of temperature rise of 10° C./min. The glass transition temperature is defined as a temperature at the intersection between lines extending from a base line and a rising line in an endothermic portion. The glass transition temperature of the binder resin (1) is 63.5° C.

### Preparation of Resin Particle Dispersion (1)

Binder Resin (1): 160 parts

Ethyl acetate: 233 parts

Sodium hydroxide aqueous solution (0.3 N): 0.1 part

The above components are put into a 1000 ml separable flask, followed by heating at 70° C. and stirring with a three-one motor (manufactured by SHINTO Scientific Co., Ltd.). As a result, a resin mixed solution is prepared. While further stirring the resin mixed solution at 90 rpm, 373 parts of ion exchange water is gradually added thereto, followed by phase-transfer emulsification and removal of a solvent. As a result, a resin particle dispersion (1) (solid content concentration: 30%) is obtained. The volume average particle diameter of the resin particle dispersion (1) is 162 nm.

### Preparation of Resin Particle Dispersion (2)

Binder Resin (1): 160 parts

Ethyl acetate: 325 parts

Sodium hydroxide aqueous solution (0.3 N): 81.5 parts

The above components are used. The other processes are performed in the same manner as that of the preparation method as that of the resin particle dispersion (1). The volume average particle diameter of the resin particle dispersion (2) is 74 nm.

### Preparation of Release Agent Dispersion

Carnauba wax (manufactured by TOA KASEI CO., LTD., RC-160): 50 parts

Anionic surfactant (manufactured by DAI-ICHI KOGYO SEIYAKU CO., LTD., NEOGEN RK): 1.0 part

Ion exchange water: 200 parts

The above components are mixed, heated to 95° C., and dispersed with a homogenizer (manufactured by IKA Japan K.K. ULTRA-TURRAX T50), followed by dispersion for 360 minutes with a Manton-Gaulin high pressure homogenizer (manufactured by Gaulin Corporation). As a result, a release agent dispersion (solid content concentration: 20%), in which release agent particles having a volume average particle diameter of 0.23 μm are dispersed, is prepared.

### Preparation of Brilliant Pigment Particles Dispersion

Aluminum pigment (manufactured by SHOWA ALUMINUM POWDER K.K., 2173EA): 100 parts

Anionic surfactant (manufactured by DAI-ICHI KOGYO SEIYAKU CO., LTD., NEOGEN R): 1.5 parts

Ion exchange water: 900 parts

After a solvent is removed from an aluminum pigment paste, the above components are mixed and dissolved thereinto, followed by dispersion with an emulsification dispersing machine CAVITRON (manufactured by Pacific Machinery & Engineering Co., Ltd., CR1010) for about 1 hour. As a result, a brilliant pigment particle dispersion (solid content concentration: 10%), in which brilliant pigment particles (aluminum pigment particles) are dispersed, is prepared

### Example 1

### Preparation of Toner

Resin particle dispersion (1): 380 parts

Release agent dispersion: 72 parts

Brilliant pigment particle dispersion: 140 parts

The brilliant pigment particle dispersion, the resin particle dispersion (1), and the release agent dispersion are put into a 2 L cylindrical stainless steel container, followed by dispersion and mixing for 10 minutes with a homogenizer (manufactured by IKA Japan K.K., ULTRA-TURRAX T50) while applying a shearing force at 4000 rpm. Next, 1.75 parts of 10% nitric acid aqueous solution of polyaluminum chloride as a coagulant is gradually added dropwise, followed by dispersing and mixing with the homogenizer at 5000 rpm for 15 minutes. As a result, a raw material dispersion is obtained.

Then, the raw material dispersion is put into a polymerization kettle which includes a stirring device using a two-paddle stirring blade for generating a laminar flow and a thermometer, followed by heating with a mantle heater under stirring at 810 rpm to promote the growth of aggregated particles at 54° C. At this time, the pH value of the raw material dispersion is adjusted to a range of 2.2 to 3.5 using 0.3 N nitric acid and 1 N sodium hydroxide aqueous solution. The resultant is held in the above pH value range for about 2 hours and aggregated particles are formed.

Next, the resin particle dispersion (1) is additionally added to attach the resin particles of the binder resin onto surfaces of the aggregated particles. Furthermore, the temperature is raised to 56° C., the aggregated particles are adjusted while checking the sizes and forms of the particles with an optical microscope and a MULTISIZER II. Next, in order to coalesce the aggregated particles, the pH value is adjusted to 8.0 and the temperature is raised to 67.5° C. After confirming that the aggregated particles are coalesced with an optical microscope, the pH value is adjusted to 6.0 while maintaining the temperature at 67.5° C. After 1 hour, heating is stopped and cooling is performed at a rate of temperature drop of 0.1° C./min. The resultant is then sieved through a 20 μm mesh, followed by repetitive washing with water and drying with a vacuum dryer. As a result, toner particles are obtained.

Furthermore, the toner particles are heated with a warm-air dryer at 45° C. for 1 hour.

1.5 parts of hydrophobic silica (manufactured by Nippon Aerosil Co., Ltd., RY50) and 1.0 part of hydrophobic titanium oxide (manufactured by Nippon Aerosil Co., Ltd., T805) are mixed and blended with 100 parts of the heated toner particles using a sample mill at 10,000 rpm for 30 seconds. Then, the resultant is sieved with a vibration sieve having an aperture of 45 μm and a toner is prepared.

The volume average particle diameter of the toner is 12.2 μm, the specific surface area X, calculated from the projected image of the toner particles, is 0.5 m²/g, and the BET specific surface area Y thereof is 1.05 m²/g.

Furthermore, “the ratio (A/B)”, “the ratio (C/D) of the average maximum thickness C to the average equivalent-circle diameter D” of a toner, and “when a cross section of a toner particle in a thickness direction thereof is observed, the number of pigment particles arranged so that an angle formed by a long axis direction of the toner particle in the cross section and a long axis direction of a pigment particle is in the range of −30° to +30° ” (hereinafter, simply referred to as “the number of pigment particles in the range of ±30° ”) are measured in the above-described methods. The results thereof are shown in Table 1 below.

### Preparation of Carrier

Ferrite Particles (volume average particle diameter: 35 μm): 100 parts

Toluene: 14 parts

Perfluoroacrylate copolymer (critical surface tension: 24 dyn/cm): 1.6 parts

Carbon black (trade name: VXC-72, manufactured by Cabot Corporation, volume resistivity: 100 Ωcm or less): 0.12 part

Cross-linked melamine resin particles (average particle diameter: 0.3 μm, insoluble in toluene): 0.3 part

First, the carbon black is diluted with the toluene and added to the perfluoroacrylate copolymer, followed by dispersion with a sand mill. Then, in the resultant, the above components other than the ferrite particles are dispersed with a stirrer for 10 minutes. As a result, a coating-layer-forming solution is prepared. Then, the coating-layer-forming solution and the ferrite particles are put into a vacuum degassing kneader, followed by stirring at 60° C. for 30 minutes. The pressure is reduced and the toluene is removed by distillation to form a resin coating layer. As a result, a carrier is obtained.

### Preparation of Developer

36 parts of the toner and 414 parts of the carrier are put into a 2 liter V blender, followed by stirring for 20 minutes. Then, the resultant is sieved through a 212 μm mesh to prepare a developer.

### Evaluation Test

An image for evaluation is formed with the following method.

A developer unit of a DocuCentre Color 400 (manufactured by Fuji Xerox Co., Ltd.) is filled with a sample developer and is left to stand for 24 hours in an environment of a temperature of 40° C. and a humidity of 70%. Then, 1,000 sheets of 1 cm×10 cm solid images (amount of toner particles deposited: 4.5 g/m²) formed on a recording paper (OK TOPCOAT+, manufactured by Oji Paper Co., Ltd.) are continuously printed under conditions of a fixing temperature of 190° C., a fixing pressure of 4.0 kg/cm², and a process speed of 308 mm/s. After 1,000 images are printed, printing is stopped for 24 hours. Then, additional 1000 images are continuously printed. The reason why printing is stopped for 24 hours after 1,000 images are printed is that the developer is left to stand to be stable and is also stable during the next continuous printing; and with such a developer, fogging easily occurs.

A degree of fogging for a 1000th printed image and a 2000th printed image; and a toner attached to a photoreceptor after 1000 images are printed and a toner attached to a photoreceptor after 2000 images are printed, are evaluated based on the following criteria. The obtained results are shown in Table 1. For the 2000th printed image, G2 to G5 are considered to be satisfactory.

In addition, the brilliance of an image is visually inspected.

### Evaluation Criteria

The evaluation for fogging is performed by visually inspecting whether or not toner fogging occurs on a non-image portion. The evaluation criteria are as follows.

G5: Fogging is not observed on both paper and a photoreceptor

G4: Fogging is observed on a photoreceptor with a loupe but does not appear on paper.

G3: Fogging is visually observed on a photoreceptor, but does not appear on paper,

G2: Fogging is observed on paper but is in an allowable range

G1: Fogging is clearly observed on paper

The evaluation for brilliance is performed by visually inspecting the 2000th printed image. The evaluation criteria are as follows.

G4: There are no problems with brilliance

G3: Brilliance deteriorates to a small degree or a small amount of darkening is observed

G2: Brilliance deteriorates or darkening is observed but is in an allowable range

G1: Brilliance deteriorates or darkening is observed and is not in an allowable range

### Example 2

The same processes as those of Example 1 are performed, except that the resin particle dispersion which is additionally added is changed to (2); and drying with warm air is not performed after vacuum drying.

The obtained toner and developer are evaluated in the same method as that of Example 1. The evaluation results are shown in Table 1.

### Example 3

The same processes as those of Example 1 are performed, except that, in the process of promoting the growth of aggregated particles, stirring is performed not at 810 rpm but at 1550 rpm; and in the process of coalescing the aggregated particles, the temperature is changed from 67.5° C. to 81.5° C.

The obtained toner and developer are evaluated in the same method as that of Example 1. The evaluation results are shown in Table 1.

### Example 4

The same processes as those of Example 1 are performed, except that, in the process of promoting the growth of aggregated particles, stirring is performed not at 810 rpm but at 450 rpm; and in the process of coalescing the aggregated particles, the temperature is changed from 67.5° C. to 59.7° C.

The obtained toner and developer are evaluated in the same method as that of Example 1. The evaluation results are shown in Table 1.

### Example 5

The same processes as those of Example 2 are performed, except that, in the process of promoting the growth of aggregated particles, stirring is performed not at 810 rpm but at 1000 rpm; and in the process of coalescing the aggregated particles, the temperature is changed from 67.5° C. to 72.5° C.

The obtained toner and developer are evaluated in the same method as that of Example 1. The evaluation results are shown in Table 1.

### Example 6

The same processes as those of Example 2 are performed, except that, in the process of promoting the growth of aggregated particles, stirring is performed not at 810 rpm but at 900 rpm; in the process of coalescing the aggregated particles, the temperature is changed from 67.5° C. to 69.6° C.; and heating is performed with a warm-air dryer at 45° C. for 1 hour.

The obtained toner and developer are evaluated in the same method as that of Example 1. The evaluation results are shown in Table 1.

### Example 7

The same processes as those of Example 2 are performed, except that, in the process of promoting the growth of aggregated particles, stirring is performed not at 810 rpm but at 750 rpm; and in the process of coalescing the aggregated particles, the temperature is changed from 67.5° C. to 65.2° C.

The obtained toner and developer are evaluated in the same method as that of Example 1. The evaluation results are shown in Table 1.

### Example 8

The same processes as those of Example 1 are performed, except that, in the process of promoting the growth of aggregated particles, stirring is performed not at 810 rpm and 54° C. but at 600 rpm and 50° C.; and in the process of coalescing the aggregated particles, the temperature is changed from 67.5° C. to 59.3° C.

The obtained toner and developer are evaluated in the same method as that of Example 1. The evaluation results are shown in Table 1.

### Example 9

The same processes as those of Example 2 are performed, except that, in the process of promoting the growth of aggregated particles, stirring is performed not at 810 rpm and 54° C. but at 500 rpm and 50° C.; and in the process of coalescing the aggregated particles, the temperature is changed from 67.5° C. to 56.6° C.

The obtained toner and developer are evaluated in the same method as that of Example 1. The evaluation results are shown in Table 1.

### Example 10

The same processes as those of Example 2 are performed, except that, in the process of promoting the growth of aggregated particles, stirring is performed not at 810 rpm and 54° C. but at 480 rpm and 50° C.; and in the process of coalescing the aggregated particles, the temperature is changed from 67.5° C. to 55.1° C.

The obtained toner and developer are evaluated in the same method as that of Example 1. The evaluation results are shown in Table 1.

### Example 11

The same processes as those of Example 2 are performed, except that, in the process of promoting the growth of aggregated particles, stirring is performed not at 810 rpm and 54° C. but at 420 rpm and 45° C.; in the process of coalescing the aggregated particles, the temperature is changed from 67.5° C. to 51.0° C.; and heating is performed with a warm-air dryer at 45° C. for 1 hour.

The obtained toner and developer are evaluated in the same method as that of Example 1. The evaluation results are shown in Table 1.

### Example 12

The same processes as those of Example 2 are performed, except that, in the process of promoting the growth of aggregated particles, stirring is performed not at 810 rpm and 54° C. but at 400 rpm and 45° C.; in the process of coalescing the aggregated particles, the temperature is changed from 67.5° C. to 49.1° C.; and heating is performed with a warm-air dryer at 45° C. for 1 hour.

The obtained toner and developer are evaluated in the same method as that of Example 1. The evaluation results are shown in Table 1.

### Comparative Example 1

A toner and a developer are obtained in the same preparation method as that of Example 1, except that heating is not performed.

The obtained toner and developer are evaluated in the same method as that of Example 1. The evaluation results are shown in Table 1.

### Comparative Example 2

The same processes as those of Example 2 are performed, except that, in the process of promoting the growth of aggregated particles, stirring is performed not at 810 rpm but at 1550 rpm; and in the process of coalescing the aggregated particles, the temperature is changed from 67.5° C. to 81.1° C.

The obtained toner and developer are evaluated in the same method as that of Example 1. The evaluation results are shown in Table 1.

### Comparative Example 3

The same processes as those of Example 1 are performed, except that, in the process of promoting the growth of aggregated particles, stirring is performed not at 810 rpm and 54° C. but at 400 rpm and 45° C.; and in the process of coalescing the aggregated particles, the temperature is changed from 67.5° C. to 50.8° C.

The obtained toner and developer are evaluated in the same method as that of Example 1. The evaluation results are shown in Table 1.

TABLE 1

| | | | Number of | | | | |
|---|---|---|---|---|---|---|---|
| | | | Pigment | | | | |
| | | | Particles in | | Fogging | | |
| | Ratio | Ratio | Range of | Ratio | 1000th | 2000th | |
| | (X/Y) | (A/B) | ±30°(%) | (C/D) | Printed Image | Printed Image | Brilliance |
| Example 1 | 0.48 | 74 | 84 | 0.079 | G4 | G4 | G4 |
| Example 2 | 0.59 | 79 | 81 | 0.091 | G5 | G5 | G4 |
| Example 3 | 0.33 | 84 | 94 | 0.0008 | G4 | G2 | G2 |
| Example 4 | 0.64 | 18 | 61 | 0.57 | G4 | G4 | G2 |
| Example 5 | 0.38 | 76 | 86 | 0.061 | G4 | G2 | G4 |
| Example 6 | 0.41 | 69 | 74 | 0.082 | G4 | G3 | G3 |
| Example 7 | 0.44 | 60 | 70 | 0.15 | G4 | G3 | G3 |
| Example 8 | 0.74 | 42 | 65 | 0.25 | G3 | G3 | G2 |
| Example 9 | 0.77 | 39 | 62 | 0.28 | G4 | G3 | G2 |
| Example 10 | 0.81 | 27 | 60 | 0.35 | G4 | G2 | G2 |
| Example 11 | 0.91 | 20 | 59 | 0.38 | G4 | G2 | G2 |
| Example 12 | 0.98 | 18 | 60 | 0.41 | G4 | G2 | G2 |
| Comparative | 0.12 | 68 | 74 | 0.064 | G3 | G1 | G3 |
| Example 1 | | | | | | | |
| Comparative | 0.28 | 80 | 90 | 0.0011 | G3 | G1 | G2 |
| Example 2 | | | | | | | |
| Comparative | 1.02 | 16 | 56 | 0.44 | G3 | G1 | G2 |
| Example 3 | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A brilliant toner comprising:
toner particles which at least contain a brilliant pigment, a binder resin, and a release agent; and
an external additive,
wherein a ratio (X/Y) of a specific surface area X (m²/g), calculated from a projected image of the toner particles, to a BET specific surface area Y (m²/g) of the toner particles is from 0.3 to 1.0.

2. The brilliant toner according to claim 1,
wherein, when a cross section of a toner particle in a thickness direction thereof is observed, the number of pigment particles arranged so that an angle formed by a long axis direction of the toner particle in the cross section and a long axis direction of a pigment particle is in the range of −30° to +30° is greater than or equal to 60% with respect to the total number of pigment particles observed.

3. The brilliant toner according to claim 1,
wherein, when a solid image formed by the toner is irradiated with incident light at an incident angle of −45° using a goniophotometer, a ratio (A/B) of a reflectance A at a light-receiving angle of +30° to a reflectance B at a light-receiving angle of −30° is from 2 to 100.

4. The brilliant toner according to claim 1,
wherein a ratio (C/D) of an average maximum thickness C to an average equivalent-circle diameter D is in the range of from 0.001 to 0.500.

5. The brilliant toner according to claim 1,
wherein the brilliant pigment contains aluminum.

6. The brilliant toner according to claim 1,
wherein a content of the brilliant pigment is from 1 part by weight to 70 parts by weight, with respect to 100 parts by weight of the binder resin.

7. The brilliant toner according to claim 1,
wherein the binder resin is a polyester resin.

8. The brilliant toner according to claim 1,
wherein a volume average particle diameter thereof is from 1 μm to 30 μm.

9. The brilliant toner according to claim 1,
wherein the brilliant pigment contains an inorganic oxide on a surface thereof.

10. The brilliant toner according to claim 9,
wherein a content of the inorganic oxide is from 0.1 parts to 5 parts by weight with respect to 100 parts by weight of the toner particles.

11. A developer comprising:
the brilliant toner according to claim 1; and
a carrier.

12. The developer according to claim 11,
wherein the carrier is coated with a resin.

13. The developer according to claim 11,
wherein a volume average particle diameter of the carrier is from 10 μm to 500 μm.

14. The developer according to claim 12,
wherein a conductive material is included in the resin with which the carrier is coated.

15. A toner cartridge which accommodates the brilliant toner according to claim 1.

16. A process cartridge which accommodates the brilliant toner according to claim 1 and includes a toner holding member that holds and transports the brilliant toner.

17. An image forming apparatus comprising:
an image holding member;
a charging device that charges a surface of the image holding member;
a latent image forming device that forms an electrostatic latent image on the surface of the image holding member;
a developing device that develops the electrostatic latent image with the developer containing the brilliant toner according to claim 11 to form a toner image; and
a transfer device that transfers the toner image, formed on the surface of the image holding member, onto a recording medium.
